(19) United States
(12) Patent Application Publication
(10) Pub. No.: US 2013/0326123 A1
(43) Pub. Date: Dec. 5, 2013

(54) MEMORY MANAGEMENT DEVICE AND METHOD, AND PROGRAM

(71) Applicant: Sony Corporation, Tokyo (JP)

(72) Inventors: Shusuke SAEKI, Tokyo (JP); Kenji FUDONO, Kanagawa (JP); Nobuhiro KANEKO, Kanagawa (JP); Kazumi SATO, Kanagawa (JP)

(73) Assignee: Sony Corporation, Tokyo (JP)

(21) Appl. No.: 13/900,682

(22) Filed: May 23, 2013

(30) Foreign Application Priority Data
May 30, 2012 (JP) 2012122852

(51) Int. Cl. G06F 12/02

(52) U.S. Cl. CPC G06F 12/0246
USPC 711/103

(57) ABSTRACT

There is provided a memory management device including a non-volatile memory that performs writing and reading of data on a per-page basis, and performs erasing on a per-block basis, and a control unit that manages a data process in the non-volatile memory by performing logical-physical translation on a per-translation unit (TU) basis, and performs a fold process. The control unit sets data of a physical TU corresponding to unnecessary logical TU information to be excluded from a copy target in the fold process based on the unnecessary logical TU information, the unnecessary logical TU information being notified of by a file system and representing a logical TU corresponding to a physical TU in which unnecessary data is physically written.

### BACKGROUND

The present technology relates to a memory management device and method, and a program, and more particularly, to a memory management device and method, and a program, which are capable of efficiently securing a free space in a non-volatile memory.

In NAND flash memories, data is electrically manipulated by “writing,” “reading,” and “erasing.” For example, since rewriting of each bit by “writing” is performed only in one direction from “1” to “0,” in order to newly write data, writing should be performed after all bits first become “1” by “erasing.”

In the NAND flash memory, as illustrated in FIG. 1, a minimum unit of “writing”/“reading” is set to a page, and a minimum unit of “erasing” is set to a block including a plurality of pages. For example, a page is configured with 528 bytes obtained by adding 16 extra bytes to 512 bytes, and a block is configured to include 32 pages.

As described above, in the NAND flash memory, since the minimum unit of “erasing” is dozens of times larger than the minimum unit of “writing,” some counter-measure are necessary in order to efficiently perform rewriting.

Further, in the NAND flash memory, an unusable block called a defective block is present at the time of shipping, and it is necessary to perform reading and writing on the NAND flash memory while avoiding a defective block.

In addition, generally, in the NAND flash memory, writing on pages in a block has to be performed in order from pages of lower numbers as illustrated in FIG. 2A. In other words, in the NAND flash memory, random writing in a block as illustrated in FIG. 2B is inhibited.

Further, in each block of the NAND flash memory, since there is an upper limit for the number of times of rewriting, it is necessary to prevent rewriting on blocks from being unequally concentrated on a specific block.

When the NAND flash memory having the above-described features is used, it is desirable to use existing file systems or tools as is or to merely slightly modify them. For this reason, the NAND flash memory has to be configured to be used without being aware of manipulation of “erasing” or a defective block. To this end, it is necessary to mount a layer (a logical-physical translation layer (hereinafter referred to as a “logical-physical translation layer”) for interpreting a request from the side (for example, the file system) using the NAND flash memory and then translating the request into a command for manipulating the NAND flash memory.

Meanwhile, a technique in which access management of a non-volatile memory is performed such that a logical address is translated into a physical address on a per-translation unit (TU) basis, each of which is an integral reciprocal of the block size and an integral multiple of the page size as illustrated in FIG. 3, and unused physical TUs are newly increased by the number of invalid physical TUs included in an original block by copying an in-use physical TU among content of a block to a block including another unused physical TU and then erasing the original block has been proposed (see JP 2009-116601 A).

According to JP 2009-116601 A, the more written invalid physical TUs (physical TUs in which invalid data is written) in a block, the more unused physical TUs which can be secured, and thus efficiency of securing a free space can be improved. The efficient securing of a free space contributes to an improvement in data rewriting performance in the non-volatile memory and an increase in the lifespan of the non-volatile memory such as the NAND flash memory from the point of view of the side using the non-volatile memory.

### SUMMARY

Meanwhile, there has recently been known a Trim command issued to implement a function of notifying of information (hereinafter, referred to as “unnecessary region information”) related to a region in which physically unnecessary data is written from a file system or the like to a logical-physical translation layer in order to efficiently secure the free space in the NAND flash memory and increase the lifespan of the NAND flash memory.

The region in which unnecessary data is written is not referred to from the file system unnecessary unless newly overwritten. Thus, in logical-physical translation layer, it is not problematic whether data of the region is deleted or continuously held as is.

However, basically, as unnecessary data is deleted in the logical-physical translation layer, the free space is efficiently secured, but in the related art, since there is no configuration in which unnecessary region information notified of by the file system is utilized, unnecessary data remains held, and it is wasteful from a point of view of securing of the free space.

The present technology is made in light of the foregoing, and directed to efficiently securing the free space in the non-volatile memory.

According to an embodiment of the present disclosure, there is provided a memory management device including a non-volatile memory that performs writing and reading of data on a per-page basis, and performs erasing on a per-block basis, and a control unit that manages a data process in the non-volatile memory by performing logical-physical translation on a per-translation unit (TU) basis, and performs a fold process. The control unit sets data of a physical TU corresponding to unnecessary logical TU information to be excluded from a copy target in the fold process based on the unnecessary logical TU information, the unnecessary logical TU information being notified of by a file system and representing a logical TU corresponding to a physical TU in which unnecessary data is physically written.

The memory management device may further include a holding unit that holds the unnecessary logical TU information.

The control unit may cause the unnecessary logical TU information held in the holding unit to be stored in the non-volatile memory as data on the file system before power is disconnected, and cause the file system to perform notification of the unnecessary logical TU information stored in the non-volatile memory at a time of activation.

The control unit may store the unnecessary logical TU information held in the holding unit in a physical TU of the non-volatile memory to which a predetermined logical TU number is set before power is disconnected, and may cause the file system to perform notification of the unnecessary logical TU information stored in a physical TU to which the predetermined logical TU number is set at a time of activation.

The control unit may cause the file system to generate and perform notification of the unnecessary logical TU information based on information related to an unused region included in management information of the file system.

The holding unit may hold a physical TU state map for managing a state of each physical TU and an unnecessary logical TU list storing the unnecessary logical TU information, and, when the file system notifies the control unit of the unnecessary logical TU information, the control unit may set a state of a physical TU corresponding to the unnecessary logical TU information in the physical TU state map to a written invalid physical TU, and may add the notified unnecessary logical TU information to the unnecessary logical TU list.

The holding unit may further hold a logical-physical translation table in which an address of a logical TU is associated with an address of a physical TU, and, when the file system notifies the control unit of the unnecessary logical TU information, the control unit may set an address of a physical TU corresponding to the unnecessary logical TU information to undefined in the logical-physical translation table.

The control unit may erase the block when all the states of the physical TUs included in the block are set to written invalid physical TUs in the physical TU state map.

When the block including a physical TU serving as a copy source of data becomes erasable as a result of a data process, the control unit may write a block number representing the block which becomes erasable in the unwritten physical TU to which the data is to be copied in the data process, and erases the block.

The data process may be rewriting of data of a logical TU in response to a request from the file system.

The data process may be the fold process.

When the block including a physical TU serving as a copy source of data does not become erasable, and another block becomes erasable as a result of the data process, the control unit may write a block number representing the other block which becomes erasable in the unwritten physical TU to which the data is to be copied in the data process, and erase the other block.

According to an embodiment of the present disclosure, there is provided a memory management method of a memory management device including a non-volatile memory that performs writing and reading of data on a per-page basis, and performs erasing on a per-block basis, and a control unit that manages a data process in the non-volatile memory by performing logical-physical translation on a per-translation unit (TU) basis, and performs a fold process, the memory management method including setting, by the memory management device, data of a physical TU corresponding to unnecessary logical TU information to be excluded from a copy target in the fold process based on the unnecessary logical TU information, the unnecessary logical TU information being notified of by a file system and representing a logical TU corresponding to a physical TU in which unnecessary data is physically written.

According to an embodiment of the present disclosure, there is provided a program for causing a computer, which includes a non-volatile memory that performs writing and reading of data on a per-page basis, and performs erasing on a per-block basis, and a control unit that manages a data process in the non-volatile memory by performing logical-physical translation on a per-translation unit (TU) basis, and performs a fold process, to execute setting data of a physical TU corresponding to unnecessary logical TU information to be excluded from a copy target in the fold process based on the unnecessary logical TU information, the unnecessary logical TU information being notified of by a file system and representing a logical TU corresponding to a physical TU in which unnecessary data is physically written.

According to another embodiment of the present technology, data of a physical TU corresponding to unnecessary logical TU information is set to be executed from a copy target in the fold process based on the unnecessary logical TU information which is notified of by a file system and represents a logical TU corresponding to a physical TU in which unnecessary data is physically written.

According to the embodiments of the present technology described above, it is possible to efficiently secure a free space in a non-volatile memory.

### BRIEF DESCRIPTION OF THE DRAWINGS

FIG. 1 is a diagram for describing a block and a page of a NAND flash memory;

FIG. 2 is a diagram for describing a writing sequence of a page in a block.

FIG. 3 is a diagram illustrating relations among a block, a page, and a translation unit (TU) of a NAND flash memory;

FIG. 4 is a diagram for describing rewriting of data;

FIG. 5 is a diagram for describing an outline of a fold process;

FIG. 6 is a diagram for describing an example of a fold process according to a related art;

FIG. 7 is a diagram for describing an example of a fold process according to the present technology;

FIG. 8 is a block diagram illustrating a configuration example of a memory management device according to the present technology;

FIG. 9 is a diagram for describing an unnecessary logical TU number acquiring process;

FIG. 10 is a flowchart for describing a data writing process;

FIG. 11 is a flowchart for describing a fold process;

FIG. 12 is a flowchart for describing an unnecessary logical TU list storing process;

FIG. 13 is a flowchart for describing an unnecessary logical TU number notifying process;

FIG. 14 is a flowchart for describing an unnecessary logical TU list storing process;

FIG. 15 is a flowchart for describing an unnecessary logical TU number notifying process;

FIG. 16 is a flowchart for describing an example of a block erasing process in a state in which a power disconnection counter-measure is executed;

FIG. 17 is a flowchart for describing a block number writing process;

FIG. 18 is a flowchart for describing another example of a block erasing process in a state in which a power disconnection counter-measure is executed;

FIG. 19 is a flowchart for describing a block number writing process; and

FIG. 20 is a block diagram illustrating a configuration example of hardware of a computer.

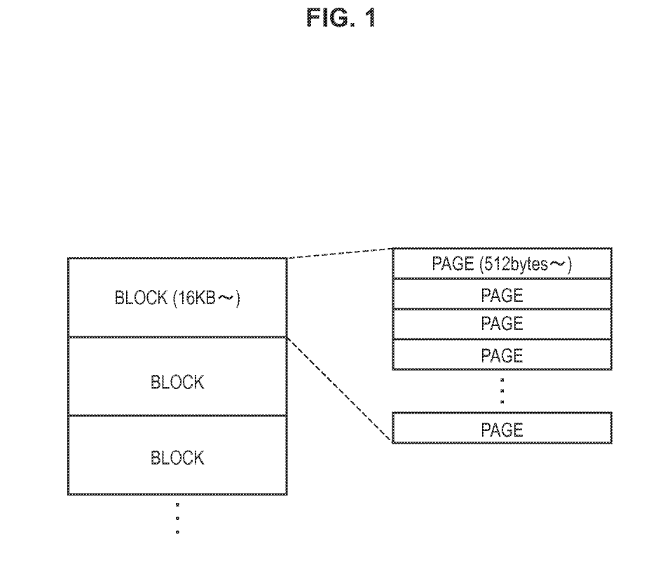

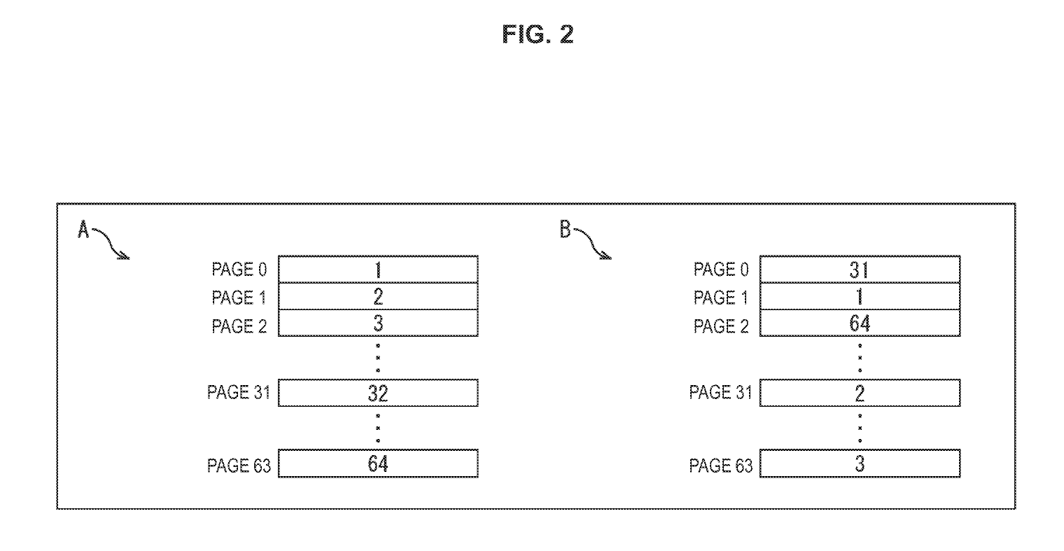

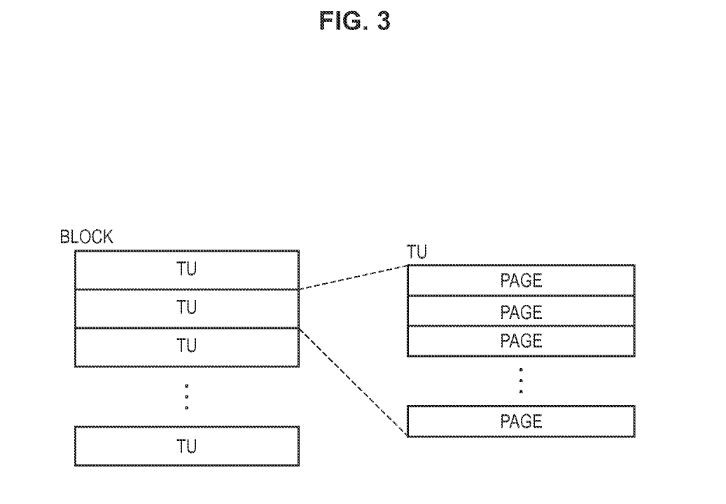

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

First of all, the related art will be described in further detail before describing an embodiment of the present technology.

[Regarding Related Art]

In the technique disclosed in JP 2009-116601 A, an actual TU on a non-volatile memory is referred to as a physical TU, and a. TU that is subjected to address translation and then provided to the side using the non-volatile memory is referred to as a logical TU. Through this operation, in the technique disclosed in JP 2009-116601 A, it is possible to flexibly set the size of data reading and writing, for example, it is possible to make a reading and writing unit match a TU in the file system.

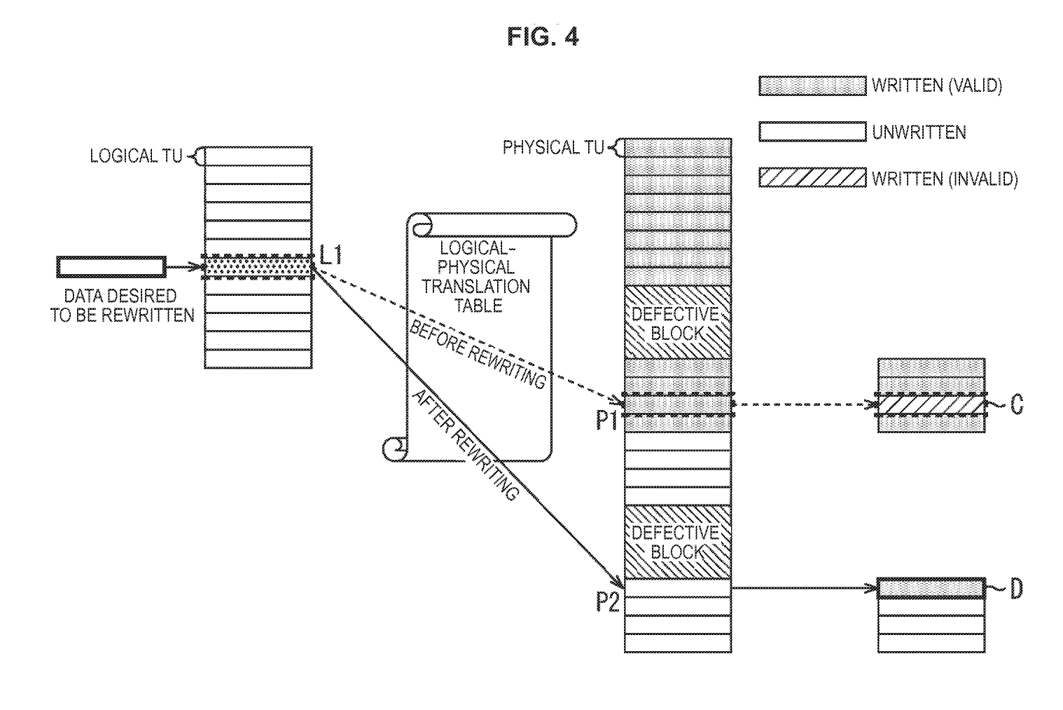

In the technique disclosed in JP 2009-116601 A, rewriting of data is performed such that data is written in an empty physical TU in which data is not recorded as illustrated in FIG. 4. Specifically, rewriting of data is performed such that a physical TU P1 in which data before rewriting is recorded is updated to an invalid state (C of FIG. 4), and new data to be rewritten is written in a physical TU P2 in which data is not recorded (D of FIG. 4). As a result, a physical TU (a written valid physical TU) of a state in which new data is recorded and a physical TU (a written invalid physical TU) of a state in which old data of an erasing target is recorded are generated.

Hereinafter, in the physical TU, a state in which new data is recorded is appropriately referred to as “INUSE,” and a state in which old data of an erasing target is recorded is “DIRTY.” Further, in the physical TU, a state in which data is not recorded after erasing or after initialization is referred to as “CLEAN.”

As described above, the non-volatile memory such as the NAND flash memory can perform erasing of data only on a per-block basis. For this reason, even when there is “a written invalid physical TU” such as the physical TU P1 of FIG. 4 among some physical TUs configuring a block, it is difficult to perform erasing when there is “a written valid physical TU.”

Thus, as rewriting of data is repeated, the number of “written invalid physical TUs” increases in the non-volatile memory, and the number of physical TUs (for example, CLEAN physical TUs) capable of performing writing of data is reduced. In other words, as writing of data is repeated, free space in the non-volatile memory is reduced.

In this regard, a fold process of increasing the number of physical TUs capable of performing writing of data and securing free space in a non-volatile memory has been proposed in JP 2009-116601 A.

The fold process refers to a process of increasing the number of unwritten physical TUs by the number of written invalid physical TUs included in a block of a copy source by copying to a block including a physical TU in which data of a written valid physical TU is not written (data is not recorded) among content of a block, and erasing the block of the copy source.

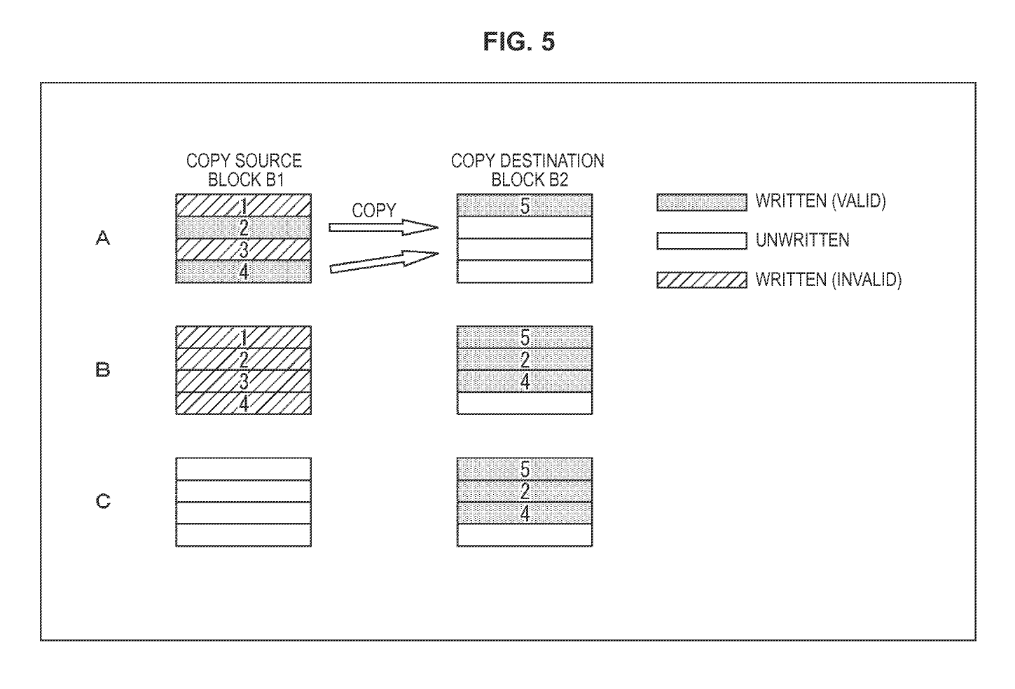

FIG. 5 illustrates an outline of the fold process.

States A, B, and C of FIG. 5 represent states of blocks B1 and B2 before the fold process, states of the blocks B1 and B2 during the fold process, and states of the blocks B1 and B2 after the fold process, respectively.

According to the fold process, written valid physical TUs of the block B1 of the copy source are copied to a block B2 of a copy destination as illustrated in the state A of FIG. 5, and the copied physical TUs in the block B1 of the copy source are updated to written invalid physical TUs as illustrated in the state B of FIG. 5. Then, the block B1 of the copy source is erased as illustrated in the state C of FIG. 5.

As described above, as the fold process is performed, the number of “unwritten physical TUs” increases, and thus the free space in the non-volatile memory increases.

However, as described above, in the related art, since there is no configuration in which unnecessary region information which is notified of by the file system and used to efficiently secure the free space in the NAND flash memory is utilized, unnecessary data remains held, and it is wasteful from a point of view of securing of the free space.

[Example of Fold Process According to Related Art]

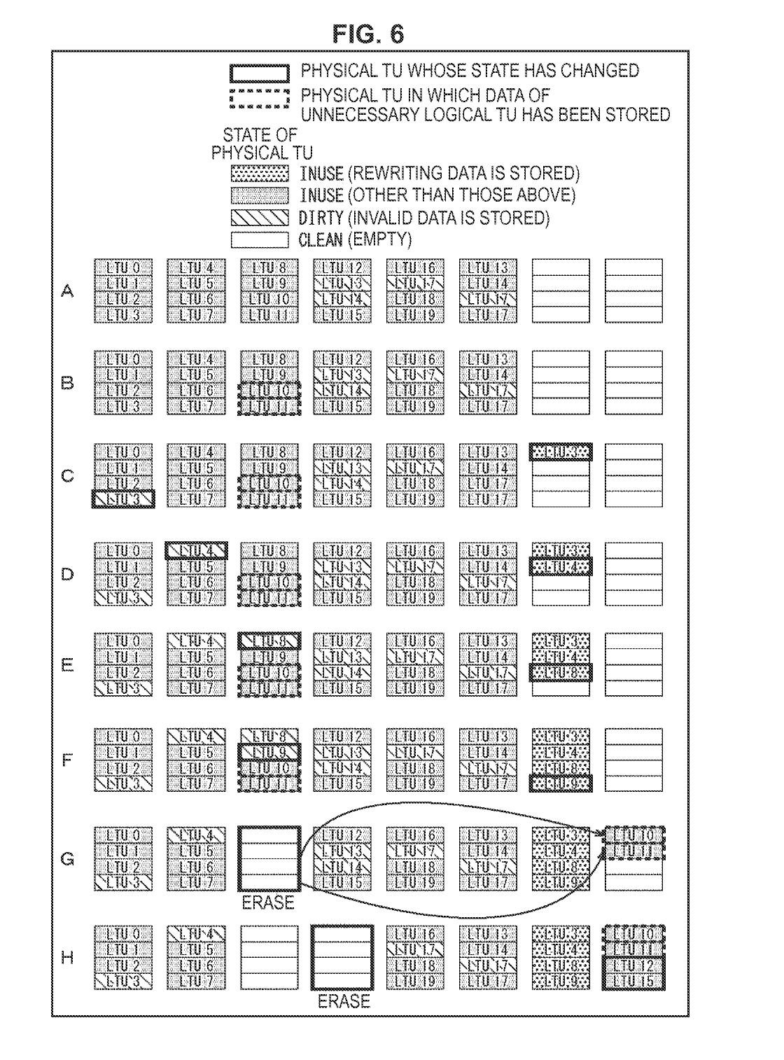

Here, an example of the fold process according to the related art which is executed without considering unnecessary region information will be described with reference to FIG. 6.

FIG. 6 illustrates states A to H of 8 blocks of a non-volatile memory in time series. Referring to FIG. 6, in a physical TU constituting each block, a number of a corresponding logical TU (LTU) and a state of a physical TU are indicated.

Here, since logical-physical translation is performed on a per-TU basis, in the following, unnecessary logical TU information (hereinafter referred to as an “unnecessary logical TU number”) representing a number of a logical TU (an unnecessary logical TU) corresponding to a physical TU in which unnecessary data is physically written as unnecessary region information is assumed to be notified of by the file system.

First of all, the state A of FIG. 6 is a state in which data of a logical TU 13 (hereinafter referred to as an “LTU 13”), an LTU 14, and an LTU 17 are rewritten in the sixth block from the left, and data of the LTU 17 is rewritten again in that block, so that the free space is reduced.

Next, the state B of FIG. 6 is a state in which an LTU 10 and an LTU 11 are notified of as unnecessary logical TU numbers. In other words, data of the LTU 10 and the LTU 11 are unnecessary data from a point of view of the file system side. However, in the related art, an unnecessary logical TU number is ignored, and unnecessary data is not deleted in the logical-physical translation layer.

The state C of FIG. 6 is a state in which rewriting of an LTU 3 is performed. As a result, data of the LTU 3 is newly written in the seventh block from the left, and a state of a physical TU in which data of the LTU 3 has been written becomes DIRTY.

The state D of FIG. 6 is a state in which rewriting of an LTU 4 is performed. As a result, data of the LTU 4 is newly written in the seventh block from the left, and a state of a physical TU in which data of the LTU 4 has been written becomes DIRTY.

The state E of FIG. 6 is a state in which rewriting of an LTU 8 is performed. As a result, data of the LTU 8 is newly written in the seventh block from the left, and a state of a physical TU in which data of the LTU 8 has been written becomes DIRTY.

The state F of FIG. 6 is a state in which rewriting of an LTU 9 is performed. As a result, data of the LTU 9 is newly written in the seventh block from the left, and a state of a physical TU in which data of the LTU 9 has been written becomes DIRTY.

Here, when the fold process is assumed to start on condition that a writing destination in which data is recently written is a last physical TU in a block, the fold process starts in the state F of FIG. 6. In other words, as illustrated in the state G of FIG. 6, data of an LTU 10 and an LTU 11 in the third block from the left are copied to the eighth block from the left, and all TUs of the third block of the copy source from the left become DIRTY physical TUs and thus are erased.

Further, when the fold process is performed, as illustrated in the state H of FIG. 6, data, of an LTU 12 and an LTU 15 in the fourth block from the left are copied to the eighth block from the left, and all TUs of the fourth block of the copy source from the left become DIRTY physical TUs and thus are erased.

Here, when the fold process is assumed to stop on condition that unwritten physical TUs (CLEAN physical TUs) are increased by the size corresponding to one block size through the fold process, the fold process stops in the state H of FIG. 6.

The fold process according to the related art is executed as described above, but in the state B of FIG. 6, an unnecessary logical TU number is ignored, and the states of physical TUs corresponding to the LTU 10 and the LTU 11 remain in the state of INUSE. As a result, in the state G of FIG. 6, data of the LTU 10 and the LTU 11 which are originally unnecessary data are copied.

In this regard, in the present technology, data of a physical TU corresponding to a notified unnecessary logical TU number is excluded from a copy target in the fold process so that a useless copy as illustrated in the state G of FIG. 6 is not made.

[Example of Fold Process According to Present Technology]

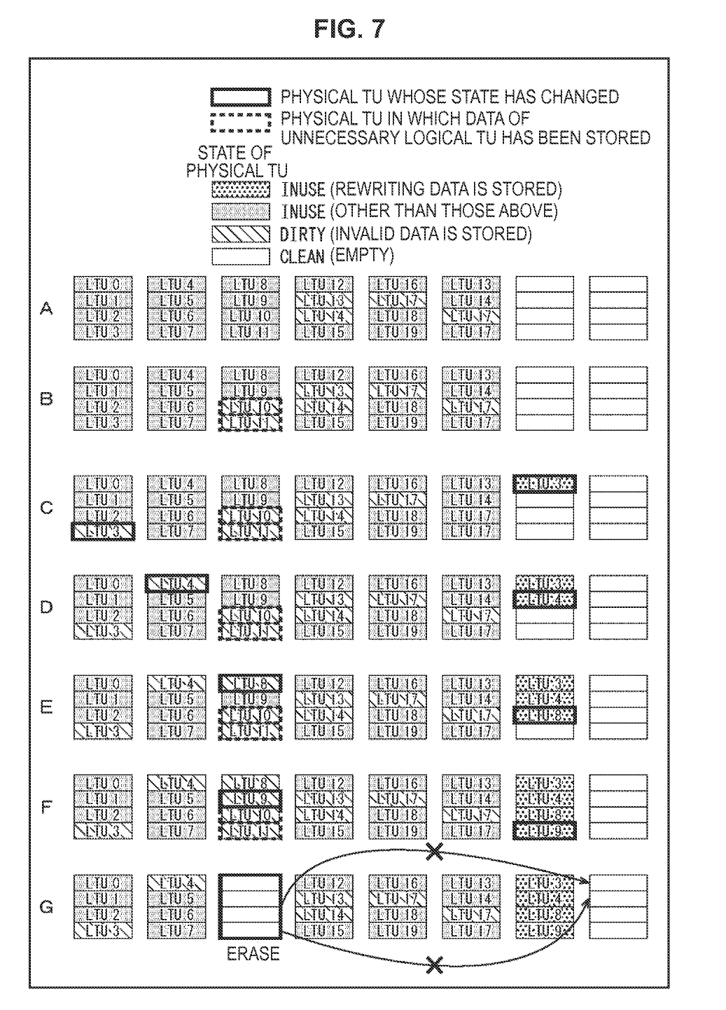

FIG. 7 illustrates an example of a fold process according to the present technology which is executed in view of unnecessary region information.

FIG. 7 also illustrates states A to G of 8 blocks of a non-volatile memory in time series, similarly to FIG. 6.

First of all, the state A of FIG. 7 is a state in which data of an LTU 13, an LTU 14, and an LTU 17 are rewritten in the sixth block from the left, and data of the LTU 17 is rewritten again in that block, so that the free space is reduced.

Next, the state B of FIG. 7 is a state in which an LTU10 and an LTU 11 are notified of as unnecessary logical TU numbers. At this time, the logical-physical translation layer side regards a state of a physical TU corresponding to an unnecessary logical TU number as DIRTY.

The state C of FIG. 7 is a state in which rewriting of an LTU 3 is performed. As a result, data of the LTU 3 is newly written in the seventh block from the left, and a state of a physical TU in which data of the LTU 3 has been written becomes DIRTY.

The state D of FIG. 7 is a state in which rewriting of an LTU 4 is performed. As a result, data of the LTU 4 is newly written in the seventh block from the left, and a state of a physical TU in which data of the LTU 4 has been written becomes DIRTY.

The state E of FIG. 7 is a state in which rewriting of an LTU 8 is performed. As a result, data of the LTU 8 is newly written in the seventh block from the left, and a state of a physical TU in which data of the LTU 8 has been written becomes DIRTY.

The state F of FIG. 7 is a state in which rewriting of an LTU 9 is performed. As a result, data of the LTU 9 is newly written in the seventh block from the left, and a state of a physical TU in which data of the LTU 9 has been written becomes DIRTY.

Here, similarly to the case of FIG. 6, when the fold process is assumed to start on condition that a writing destination in which data is recently written is a last physical TU in a block, the fold process starts in the state F of FIG. 7, but as illustrated in the state G of FIG. 7, since the physical TUs corresponding to the LTU 10 and the LTU 11 in the third block from the left have already been set to DIRTY in the state B of FIG. 7, data of the LTU 10 and the LTU 11 is not copied, and the third block from the left is erased.

Further, similarly to the case of FIG. 6, when the fold process is assumed to stop on condition that unwritten physical TUs (physical TUs of CLEAN) are increased by the size corresponding to one block size through the fold process, the fold process stops in the state G of FIG. 7.

The start condition and the stop condition of the fold process are not limited to the above example.

As described above, in the fold process according to the present technology, in the state B of FIG. 7, the states of the physical TUs corresponding to the LTU 10 and the LTU 11 notified of as the unnecessary logical TU number become DIRTY, and data of the LTU 10 and the LTU 11 is set to be excluded from the copy target in the fold process.

As a result, for the same processing request from the file system, in the example of FIG. 6, block erasing is performed twice, and copying corresponding to one block is performed, whereas in the example of FIG. 7, only single block erasing is performed. Thus, according to the present technology; it is possible to efficiently secure the free space in the non-volatile memory, and thus it is possible to improve data rewriting performance in the non-volatile memory and increase the lifespan of the non-volatile memory such as the NAND flash memory.

[Configuration Example of Memory Management Device]

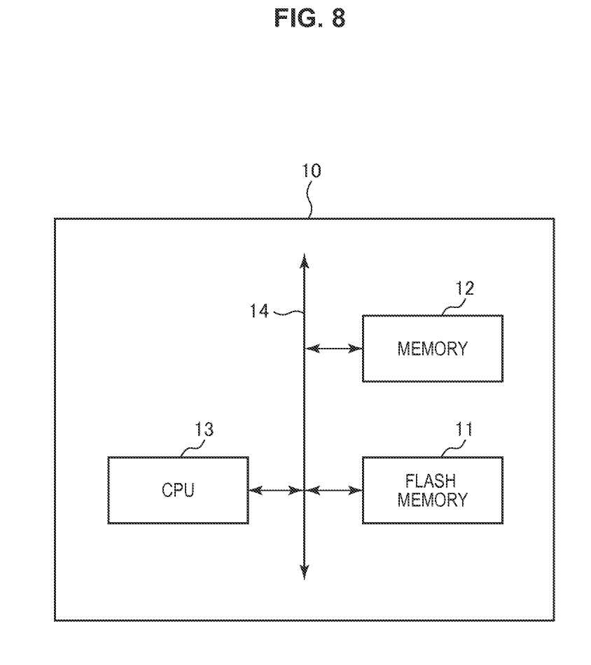

FIG. 8 illustrates a configuration example of a memory management device applying the present technology.

A memory management device 10 includes a NAND flash memory 11, which is the non-volatile memory, a memory 12 configured with a volatile memory such as a dynamic random access memory (DRAM) or a static random access memory (SRAM), and a central processing unit (CPU) 13 serving as a control unit. The NAND flash memory 11, the memory 12, and the CPU 13 are connected with one another via a bus 14.

The NAND flash memory 11 includes a memory cell array in which NAND strings including a plurality of memory cells serially connected to each other are arranged in an array form, and is able to electrically perform writing, reading, and erasing.

A minimum unit of writing/reading of the NAND flash memory 11 is a page, and a minimum unit of erasing is a block including a plurality of pages. For example, the page is configured with 528 bytes in which an expansion region of 16 bytes is added to a data region of 512 bytes, that is, 4224 bits, and the block includes 32 pages.

Access management to the NAND flash memory 11 is performed according to control of the CPU 13 based on management information written in the expansion region, and information of a logical-physical translation table constructed in the memory 12, a physical TU state map, and an unnecessary logical TU list. Further, access to the NAND flash memory 11 includes memory access related to manipulations of writing, reading, and erasing.

The memory 12 includes a read only memory (ROM) for program storage and a RAM which is a working memory. In the memory 12, the logical-physical translation table, the physical TU state map, and the unnecessary logical TU list are constructed and held under control of the CPU 13.

The CPU 13 functions as a control unit that controls access to the NAND flash memory 11 based on the management information written in the expansion region of the NAND flash memory 11, the logical-physical translation table constructed in the memory 12, the physical TU state map, and the information of the unnecessary logical TU list constructed in the memory 12.

The CPU 13 performs the logical-physical translation and access management of the NAND flash memory 11 on a per-TU basis which is an integral reciprocal of the block size and an integral multiple of the page size.

Further, the CPU 13 has a function of performing the fold process of increasing the number of unwritten physical TUs by the number of written invalid physical TUs included in a block of a copy source by copying data of written valid physical TUs among content of a block to a block including unwritten physical TUs (in which data is not recorded) and erasing the block of the copy source.

[Data Structure on Memory]

Here, a data structure on the memory 12 will be described.

On the memory 12, the logical-physical translation table, the physical TU state map, and the unnecessary logical TU list are formed.

The logical-physical translation table is a table used to obtain a corresponding physical TU number (address) from a logical TU number (address). When there is no physical TU corresponding to a logical TU number, the physical TU number is set to UNDEF (undefined).

The physical TU state map is a map for managing a state of each physical TU, and the following four types are used as the states.

CLEAN: an unwritten state after erasing manipulation is performed.

INUSE: a state in which valid data referred to by the logical-physical translation table is stored.

DIRTY: a state in which invalid data referred to by the logical-physical translation table is stored.

DEFECT: a state in which a physical TU is present among defective blocks.

The unnecessary logical TU list is a list including notified unnecessary logical TU information (unnecessary logical TU number). When a logical TU number of newly written data is included in the unnecessary logical TU list, the corresponding logical TU number is deleted from the unnecessary logical TU list.

In the following, various kinds of operations performed according to control of the CPU 13 will be described.

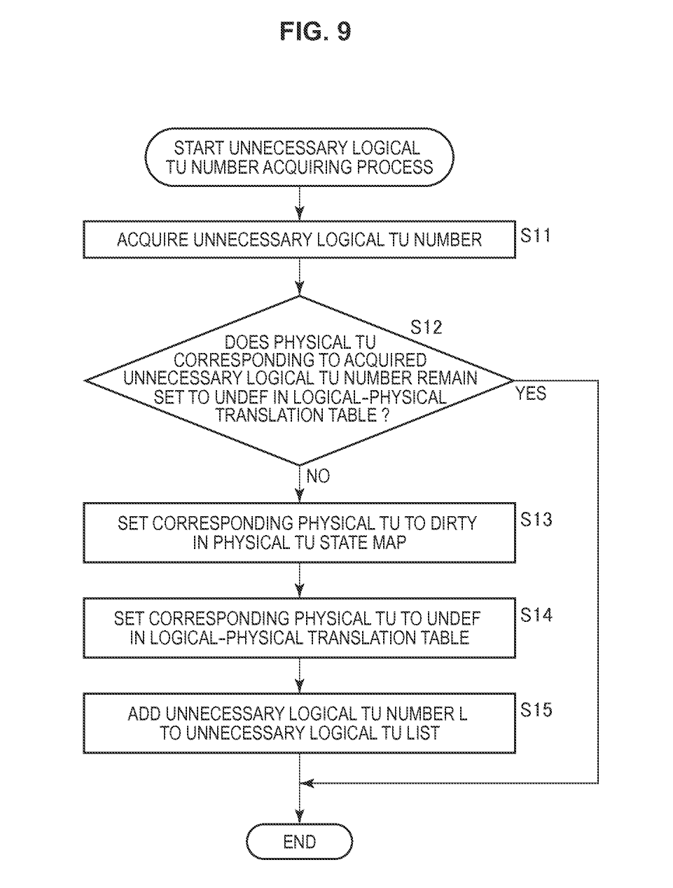

First of all, a process of acquiring an unnecessary logical TU number notified of from the side using the NAND flash memory 11 of the file system or the like will be described with reference to FIG. 9.

[Unnecessary Logical TU Number Acquiring Process]

First of all, in step S11, the CPU 13 acquires an unnecessary logical TU number L notified of from the side using the NAND flash memory 11.

In step S12, the CPU 13 determines whether or not the physical TU number corresponding to the acquired unnecessary logical TU number L remains set to UNDEF (undefined) in the logical-physical translation table with reference to the logical-physical translation table of the memory 12.

In step S12, when it is determined that the physical TU number corresponding to the acquired unnecessary logical TU number L does not remain set to UNDEF (undefined), the process proceeds to step S13.

In step S13, the CPU 13 sets the state of the physical TU corresponding to the acquired unnecessary logical TU number L to DIRTY in the physical TU state map with reference to the physical TU state map on the memory 12.

In step S14, the CPU 13 sets the physical TU number corresponding to the acquired unnecessary logical TU number L to UNDEF in the logical-physical translation table with reference to the logical-physical translation table of the memory 12.

In step S15, the CPU 13 adds the acquired unnecessary logical TU number L to the unnecessary logical TU list of the memory 12, and then the process ends.

Meanwhile, when it is determined in step S12 that the physical TU number corresponding to the acquired unnecessary logical TU number L remains set to UNDEF, steps S13 to S15 are not performed, and the process ends.

According to the above process, in the physical TU state map, the state of the physical TU corresponding to the unnecessary logical TU number notified of from the side using the NAND flash memory 11 is set to DIRTY. Thus, since the physical TU corresponding to the unnecessary logical TU number is set to be excluded from the copy target in the fold process, as described above with reference to FIG. 7, it is possible to efficiently secure the free space in the non-volatile memory, and thus it is possible to improve data rewriting performance in the non-volatile memory and increase the lifespan of the non-volatile memory such as the NAND flash memory.

Next, a data reading operation will be described.

[Reading of Data]

The CPU 13 translates a logical TU number on which reading is to be performed into a physical TU number with reference to the logical-physical translation table of the memory 12. Then, the CPU 13 specifies a physical TU on which reading of data is to be executed from the translated physical TU number, and reads a corresponding data region.

Here, when there is no physical TU corresponding to a logical TU number on which reading is to be performed (the case of UNDEF), reading of the data region is not performed, and data is returned by filling of 0xff or filling of 0x00.

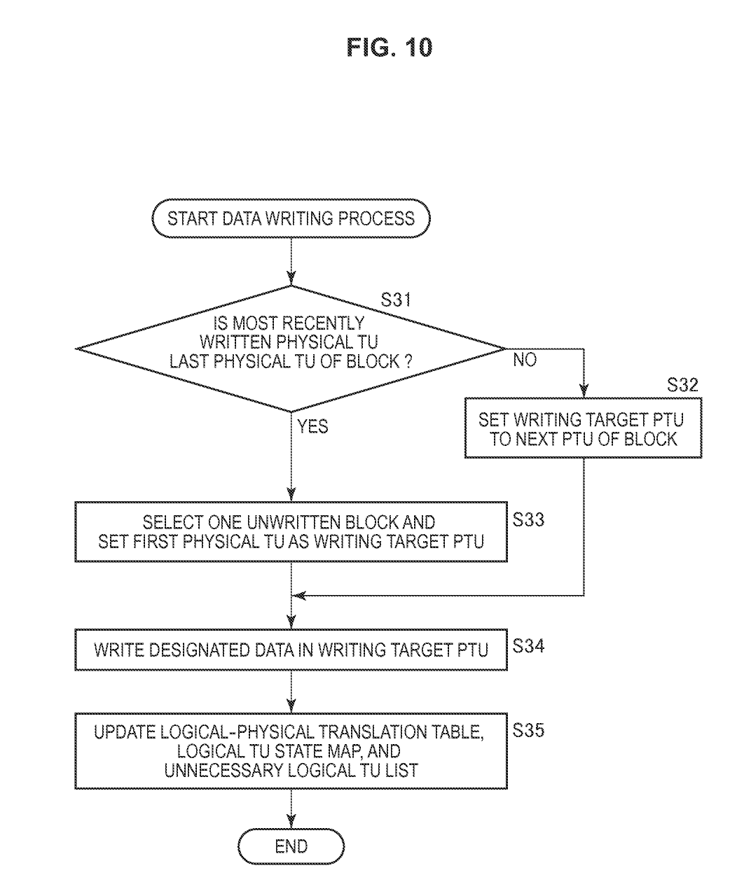

Next, a data writing operation will be described with reference to a flowchart of FIG. 10.

[Writing of Data]

First of all, in step S31, the CPU 13 determines whether or not the most recently written physical TU is the last physical TU of a block.

When it is determined in step S31 that the most recently written physical TU is not the last physical TU of a block, the process proceeds to step S32.

In step S32, the CPU 13 sets a physical TU of a writing target (hereinafter referred to as a “writing target PTU”) as a next PTU (physical TU) of a block.

However, when it is determined in step S31 that the most recently written physical TU is the last physical TU of a block, the process proceeds to step S33.

In step S33, the CPU 13 selects a block in which the first physical TU in a block is an “unwritten physical TU,” and sets the first physical TU in the block as a writing target PTU.

After step S32 or step S33, in step S34, the CPU 13 writes designated data in the set writing target PTU.

In step S35, the CPU 13 updates the logical-physical translation table of the memory 12, the physical TU state map, and the unnecessary logical TU list.

Specifically, if a number of a logical TU in which writing is demanded is set to L′, when a physical TU number previously corresponding to the logical TU number L′ in the logical-physical translation table does not remain set to UNDEF, the CPU 13 sets the state of the corresponding physical TU and the state of the writing target PTU to DIRTY and INUSE, respectively, in the physical TU state map.

Further, the CPU 13 associates the logical TU number L′ with the number of the writing target PTU in the logical-physical translation table.

Furthermore, when the logical TU number L′ is included in the unnecessary logical TU list, the CPU 13 deletes the logical TU number L′ from the unnecessary logical TU list.

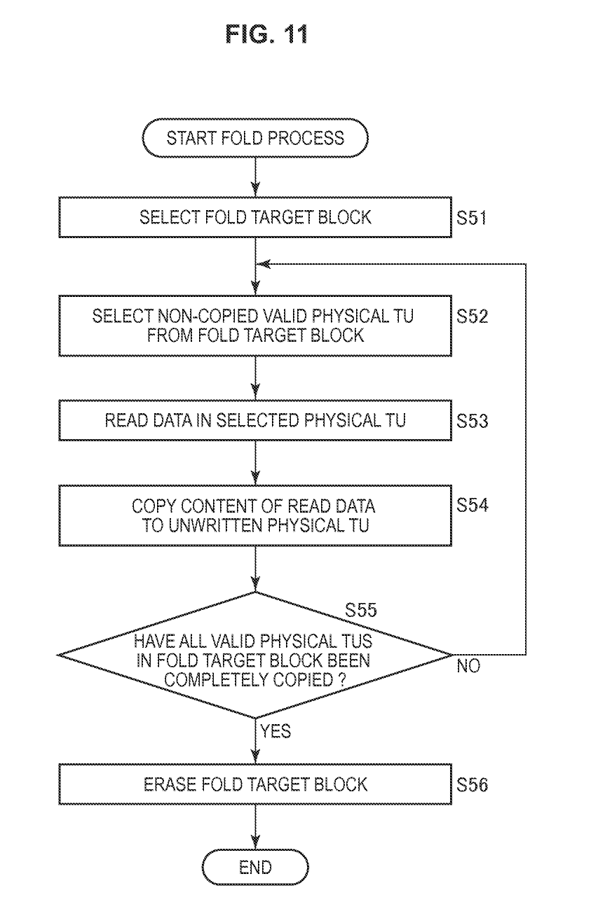

Next, an operation in the fold process will be described with reference to a flowchart of FIG. 11. The fold process illustrated in FIG. 11 is assumed to start when a predetermined start condition is satisfied and be repeated until a predetermined end condition is satisfied.

[Fold Process]

First of all, in step S51, the CPU 13 selects a block serving as a target of the fold process (hereinafter, referred to as a “fold target block”). Here, for example, a block having a larger number of “written invalid physical TUs” (DIRTY physical TUs) is selected from among blocks in the NAND flash memory 11.

In step S52, the CPU 13 selects a “written valid physical TU” (an INUSE physical TU) which is not copied from the selected fold target block.

In step S53, the CPU 13 reads data in the selected physical TU.

In step S54, the CPU 13 copies content of the read data to an unwritten physical TU in a block of a copy destination.

In step S55, the CPU 13 determines whether or not all “written valid physical TUs” in the fold target block have been completely copied.

When it is determined in step S55 that not all “written valid physical TUs” in the fold target block have been completely copied, the process returns to step S52, and the subsequent process is repeated.

However, when it is determined in step S55 that all “written valid physical TUs” in the fold target block have been completely copied, the process proceeds to step S56. In step S56, the CPU 13 erases the fold target block, and the process ends.

According to the above process, the number of “unwritten physical TUs” (CLEAN physical TUs) increases, and thus the free space in the non-volatile memory increases. Further, when a physical TU corresponding to the unnecessary logical TU number is present in the fold target block, the corresponding physical TU is the “written invalid physical TU” (DIRTY physical TU) and thus excluded from the copy target. In other words, as described above with reference to FIG. 7, it is possible to efficiently secure the free space in the non-volatile memory, and thus it is possible to improve data rewriting performance in the non-volatile memory and increase the lifespan of the non-volatile memory such as the NAND flash memory.

Next, table construction at the time of activation will be described.

[Table Construction at Time of Activation]

As described above, the logical-physical translation table, the physical TU state map, and the unnecessary logical TU list are data on the memory 12, and thus lost when power is disconnected. On the other hand, a technique of recovering the logical-physical translation table and the physical TU state map at the time of re-activation after power is disconnected by scanning management information written in an expansion region of a physical TU on a per-block basis is disclosed in JP 2009-116601A. The management information written in an expansion region of a physical TU includes a logical LTU number corresponding to a corresponding physical TU and a number representing a writing sequence assigned to each block.

However, in the technique disclosed in JP 2009-116601 A, if a physical TU corresponding to an unnecessary logical TU number included in the unnecessary logical TU list is not erased but present in the NAND flash memory 11 at the time of power disconnection, the table is recovered and constructed in a state in which the state of the physical TU corresponding to the unnecessary logical TU number is INUSE at the time of re-activation.

In this case, the physical TU corresponding to the unnecessary logical TU number is not referred to by the file system side, but since the unnecessary logical TU list is lost, the logical-physical translation layer side determines that the state is INUSE. Thus, unnecessary data remains held, and it is difficult to efficiently secure the free space.

In this regard, a technique of recovering the unnecessary logical TU list at the time of re-activation after power is disconnected will be described below.

First of all, a first technique of recovering the unnecessary logical TU list at the time of re-activation after power is disconnected will be described.

[Technique of Holding Unnecessary Logical TU List as Data on File System and Notifying of Unnecessary Logical TU Number]

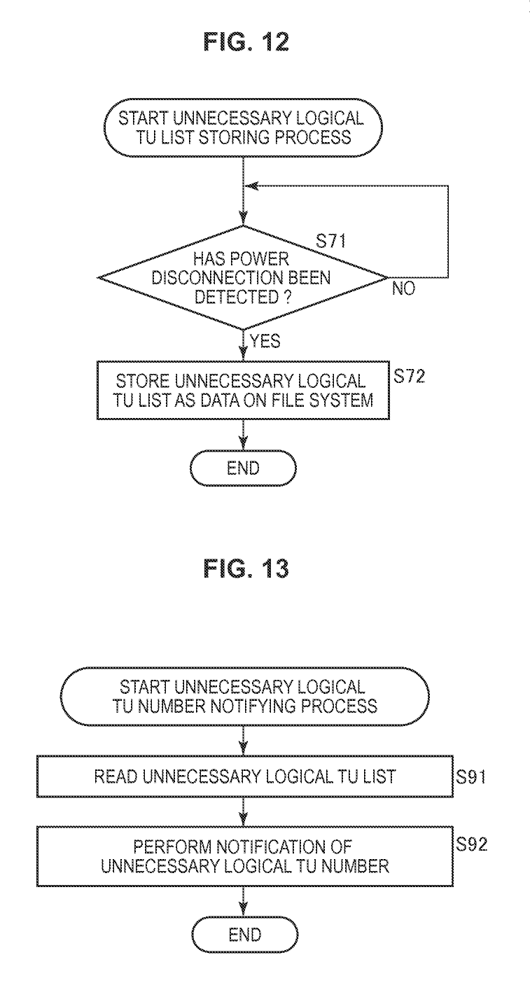

FIG. 12 is a flowchart for describing a process of storing the unnecessary logical TU list.

In step S71, the CPU 13 determines whether or not power disconnection has been detected. In step S71, the process does not proceed until power disconnection is detected.

When it is determined in step S71 that power disconnection is detected, the process proceeds to step S72 immediately before power is disconnected in step S72, the CPU 13 stores the unnecessary logical TU list of the memory 12 in a data region of the NAN D flash memory 11 as data of the file system.

As described above, the unnecessary logical TU list is stored immediately before power is disconnected.

FIG. 13 is a flowchart for describing a process of notifying of an unnecessary logical TU number. The unnecessary logical TU number notifying process of FIG. 13 is executed at the time of re-activation after power is disconnected.

In step S91, the CPU 13 reads the unnecessary logical TU list stored in the data region of the NAND flash memory 11.

In step S92, the CPU 13 causes the file system to notify of the unnecessary logical TU number based on the read unnecessary logical TU list.

When the unnecessary logical TU number is notified of from the file system as described above, the unnecessary logical TU list is reconstructed in the logical-physical translation layer as described above with reference to the flowchart of FIG. 9.

Next, a second technique of restoring the unnecessary logical TU list at the time of re-activation after power is disconnected will be described.

[Technique of Storing Unnecessary Logical TU List in Logical-Physical Translation Layer Side and Notifying of Unnecessary Logical TU Number]

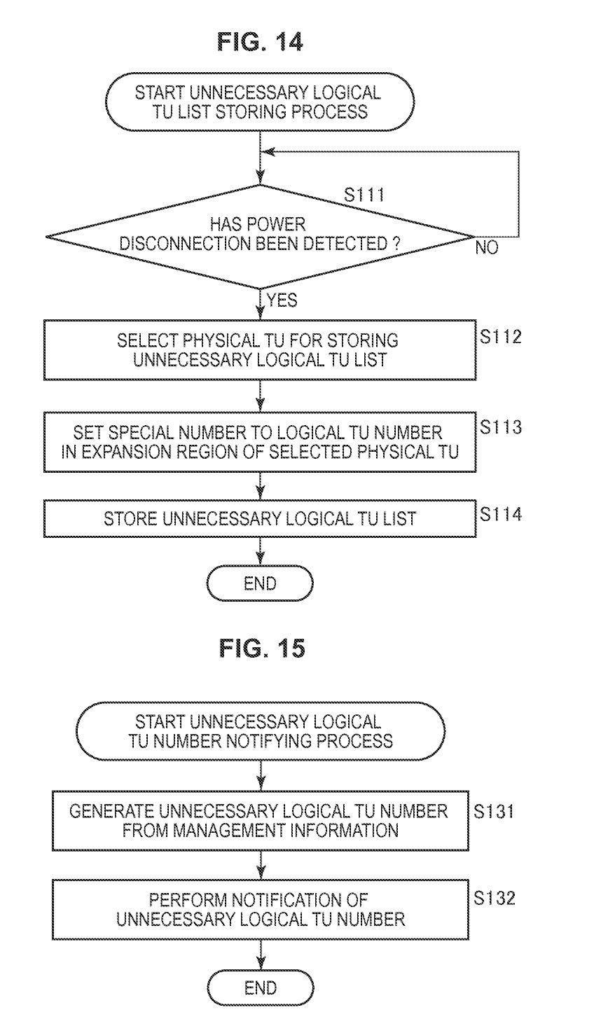

FIG. 14 is a flowchart for describing a process of storing the unnecessary logical TU list in the logical-physical translation layer side.

In step S111, the CPU 13 determines whether or not power disconnection has been detected. In step S111, the process does not proceed until power disconnection is detected.

When it is determined in step S111 that power disconnection has been detected, the process proceeds to step S112 immediately before power is disconnected. In step S112, the CPU 13 selects an unwritten physical TU for storing the unnecessary logical TU list of the memory 12.

In step S113, the CPU 13 sets a special number to a logical TU number included in management information written in an expansion region of the selected physical TU. Thus, the physical TU for storing the unnecessary logical TU list is distinguished from the other physical TUs in which data from the file system is stored.

In step S114, the CPU 13 stores the unnecessary logical TU list of the memory 12 in a data region of the physical TU to which the special number is set.

As described above, the unnecessary logical TU list is stored before power is disconnected.

The stored unnecessary logical TU list is read, and the unnecessary logical TU number is notified of, similarly to the unnecessary logical TU number notifying process which is executed at the time of re-activation after power is disconnected and described above with reference to the flowchart of FIG. 13. As a result, the unnecessary logical TU list is reconstructed in the logical-physical translation layer as described above with reference to the flowchart of FIG. 9.

Further, a third technique of recovering the unnecessary logical TU list at the time of re-activation after power is disconnected will be described.

[Technique of Generating Unnecessary Logical TU Number from Management Information of File System and Notifying of Unnecessary Logical TU Number]

FIG. 15 is a flowchart for describing a process of generating and notifying of an unnecessary logical TU number. The process of FIG. 15 is executed at the time of re-activation after power is disconnected.

In step S131, the CPU 13 generates an unnecessary logical TU number from information related to an unused region included in the management information of the file system.

Generally, the file system is aware of a region used to store data and an unused region in a region to be used by itself through its management information. Thus, the file system can recognize an unused region as an unnecessary logical TU from information related to an unused region included in the management information and generate an unnecessary logical TU number. For example, when the file system is a file allocation table (FAT) file system, the unnecessary logical TU number is generated from the table.

In step S132, the CPU 13 causes the file system to notify of the generated unnecessary logical TU number.

When the file system notifies of the unnecessary logical TU number as described above, the unnecessary logical TU list is reconstructed in the logical-physical translation layer as described above with reference to the flowchart of FIG. 9.

In the process of FIG. 15, it takes time to collect information related to an unused region, but it is possible to exhaustively notify the logical-physical translation layer of the unnecessary logical TU information.

The process of FIG. 15 is assumed to be executed at the time of re-activation after power is disconnected but may be executed using a vacant time of a system.

According to the above-described process, since the unnecessary logical TU list is recovered at the time of re-activation after power is disconnected, unnecessary data does not remain stored, and thus it is possible to efficiently secure the free space in the non-volatile memory, and it is possible to improve data rewriting performance in the non-volatile memory and increase the lifespan of the non-volatile memory such as the NAND flash memory.

[Regarding Counter-Measure on Power Disconnection in Process of Writing or Erasing]

Next, a technique for normalizing a storage state of data in the NAND flash memory 11 according to a system recovery process executed after a system down caused by power blackout, a malfunction, or the like occurs will be described.

When power is disconnected in the process of writing on the NAND flash memory 11, data of a physical TU which is being written or management information is likely to be a halfway value. Further, when power is disconnected in the process of erasing the NAND flash memory 11, data of a physical TU in a block which is being erased or management information is likely to remain without being completely erased. As a result, at the time of re-activation, a physical TU of a halfway state may be recognized as a valid physical TU and used, or may be recognized as an unwritten physical TU and overwritten.

In this regard, a technique of correcting a physical TU in a halfway state by writing information representing completion of writing in an expansion region of a physical TU immediately after writing or checking cyclic redundancy check (CRC) information included in management information written in an expansion region of a physical TU at the time of re-activation is disclosed in JP 2009-116601 A.

A technique of enhancing a counter-measure on power disconnection in the process of erasing will be described below.

[First Enhancement of Counter-Measure on Power Disconnection in Process of Erasing]

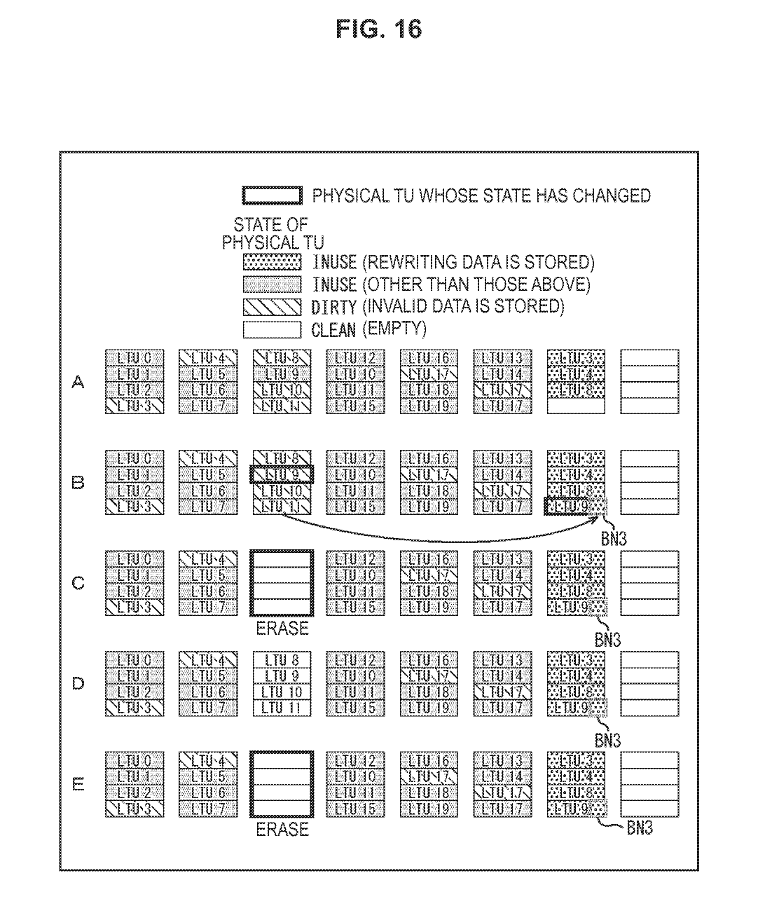

First of all, an example of a block erasing process in a state in which a power disconnection counter-measure is executed will be described with reference to FIG. 16.

FIG. 16 illustrates states A to E of 8 blocks of a non-volatile memory in time series.

First of all, the state A of FIG. 16 is a state in which data of an LTU 13, art LTU 14, and an L TU 17 are rewritten in the sixth block from the left, data of the LTU 17 is further rewritten in that block, and rewriting of an LTU 3, an LTU4, and an LIU 8 is performed, so that data of the LTU 3, the LTU4, and the LTU 8 are newly written in the seventh block from the left.

The state B of FIG. 16 is a state in which rewriting of an LTU 9 is performed. As a result, data of the LTU 9 is newly written in the seventh block from the left, and the state of the physical TU in which data of the LTU 9 has been written is set to DIRTY.

As a result, all physical TUs of the third block from the left are set to DIRTY, and are in an erasable state as in the state C of FIG. 16. At this time, data of the LTU 9 is written in the physical TU of the seventh block from the left, and a number (hereinafter referred to an “erasing block number”) BN3 of the third block from the left which is erasable is written in an expansion region of the physical TU in which data of the LTU 9 is written.

Here, in the state C of FIG. 16, power is assumed to be disconnected in the process of erasing the third block from the left.

The state D of FIG. 16 is a state of a non-volatile memory at the time of re-activation after power is disconnected. In the state D of FIG. 16, since power is disconnected in the process of erasing, the state of the third block from the left becomes a halfway state.

In this regard, in the state E of FIG. 16, the third block from the left is erased based on the erasing block number BN3 written in the expansion region of the physical TU in which data is lastly written in the fold process, that is, data of the LTU 9 is written.

As described above, even when power is disconnected in the process of erasing a block, a block in a halfway state is reliably erased at the time of re-activation.

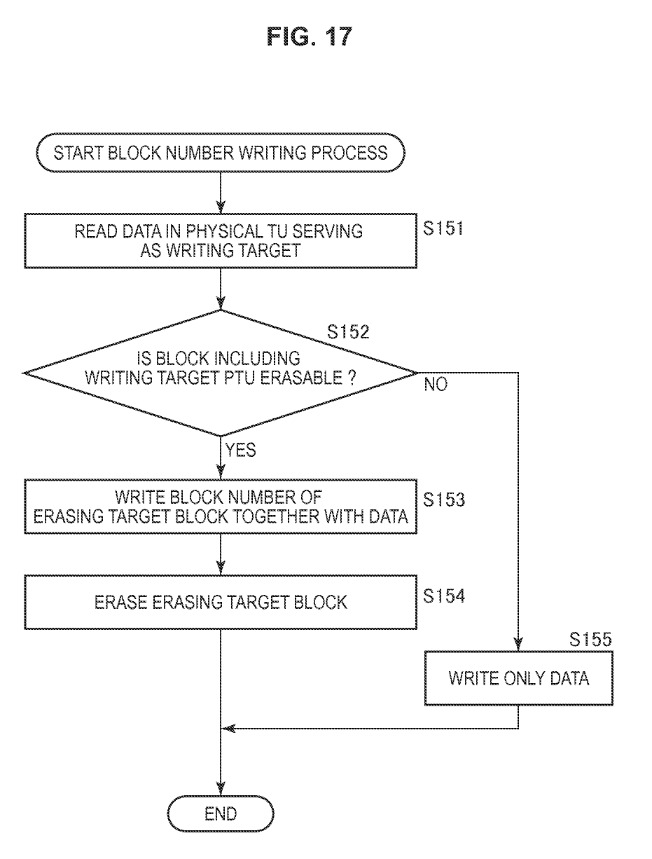

Next, a process of writing a block number in the process of block erasing described above with reference to FIG. 16 will be described with reference to a, flowchart of FIG. 17.

Erasing of a block is executed not only when an erasable block (a block in which states of all physical TUs included therein are set to DIRTY) occurs as a result of a process of rewriting of data of a physical TU in response to a request from the file system as described above with reference to FIG. 16, but also when a block of a copy source is erasable in the fold process.

In other words, in step S151, the CPU 13 reads data of a physical TU (of a copy source) serving as a writing target in rewriting of data of a logical TU or the fold process.

In step S152, the CPU 13 determines whether or not a block including the writing target PTU is erasable.

When it is determined in step S152 that the block including the writing target PTU is erasable, the process proceeds to step S153. In step S153, the CPU 13 writes data to be written (copied) in a physical TU of a writing destination (a copy destination), and writes a block number (an erasing block number) of an erasing target block in an expansion region of the physical TU of the writing destination (copy destination).

Then, in step S154, the CPU 13 erases the erasing target block, and then the process ends.

However, when it is determined in step S152 that the block including the writing target PTU is not erasable, the process proceeds to step S155. In step S155, the CPU 13 writes data to be written (copied) in the physical TU of the writing destination (the copy destination), and then the process ends.

According to the above-described process, a block number (an erasing block number) of an erasable block in a predetermined data process is stored together with data lastly copied from the erasing target block. Thus, even when power is disconnected in the process of erasing a block in a predetermined data process, a block in a halfway state can be reliably erased with reference to the erasing block number at the time of re-activation.

[Second Enhancement of Counter-measure on Power Disconnection in Process of Erasing]

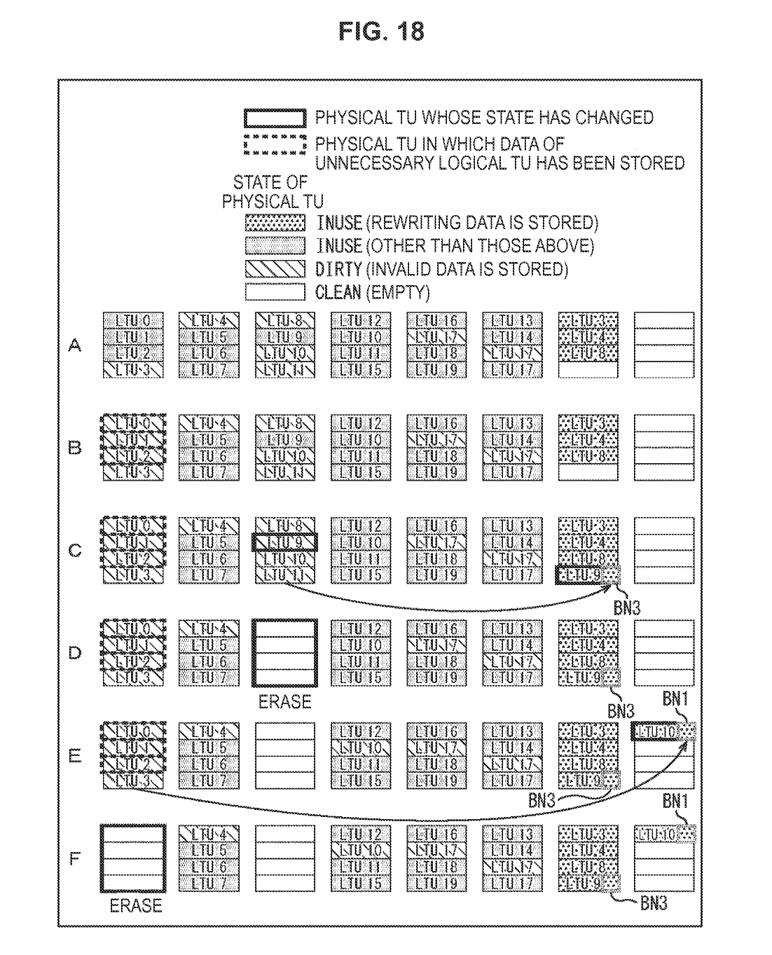

Next, another example of a block erasing process in a state in which a power disconnection counter-measure is executed will be described with reference to FIG. 18.

FIG. 18 illustrates states A to E of 8 blocks of a non-volatile memory in time series.

Similarly to the state A of FIG. 16, the state A of FIG. 18 is a state in which data of an LTU 13, an LTU 14, and an LTU 17 are rewritten in the sixth block from the left, data of the LTU 17 is rewritten again in that block, and rewriting of an LTU 3, an LTU4, and an LTU 8 is performed, so that data of the LTU 3, the LTU4, and the LTU 8 are newly written in the seventh block from the left.

Next, the state B of FIG. 18 is a state in which an LTU 0, an LTU 1, and an LTU 2 are notified of as an unnecessary logical TU number. At this time, the logical-physical translation layer side regards a state of a physical TU corresponding to an unnecessary logical TU number as DIRTY.

The state C of FIG. 18 is a state in which rewriting of an LTU 9 is performed. As a result, data of the LTU 9 is newly written in the seventh block from the left, and the state of the physical TU in which data of the LTU 9 has been written is set to DIRTY.

As a result, all physical TUs of the third block from the left are set to DIRTY, and are in an erasable state as in the state D of FIG. 18, and a number (an erasing block number) BN3 of the third block from the left which is erasable is written an expansion region of the physical TU in which data of the LTU 9 is written.

The state E of FIG. 18 is a state in which rewriting of an LIU 10 is performed. As a result, data of the LTU 10 is newly written in the eighth block from the left. At this time, all physical TUs of the first block from the left are set to DIRTY and erasable.

In this regard, in the state E of FIG. 18, a number (an erasing block number) BN1 of the first block from the left which is erasable is written in an expansion region of the physical TU in which data of the LTU 10 is written.

Then, in the state F of FIG. 18, the first block from the left which is erasable is erased.

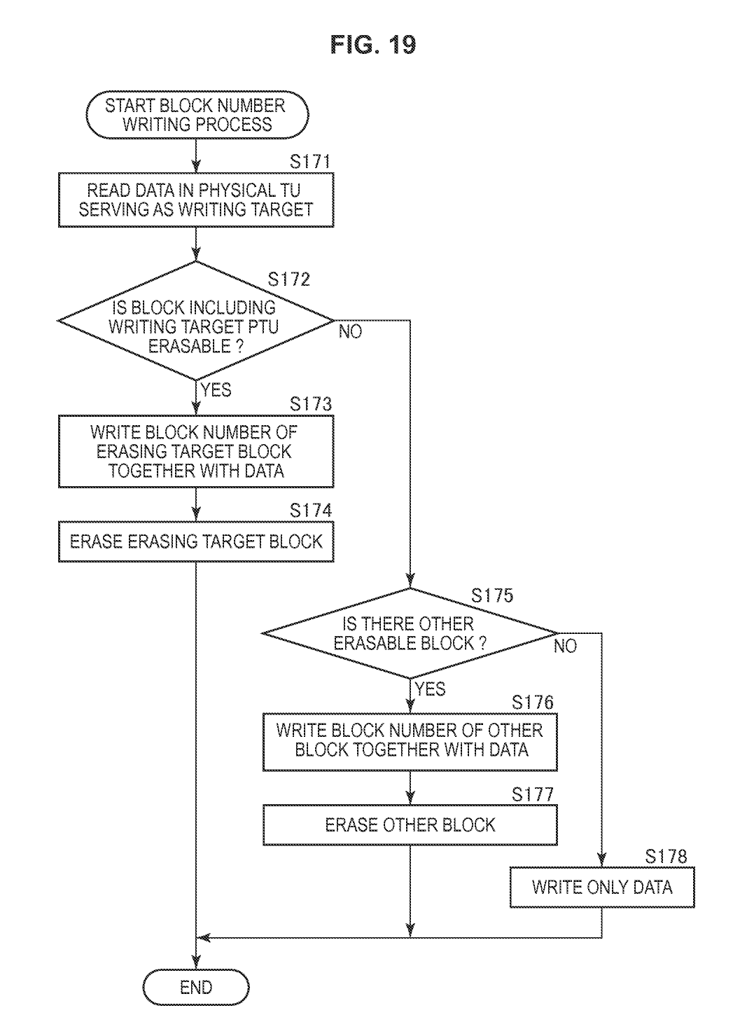

Next, a process of writing a block number in the process of block erasing described above with reference to FIG. 18 will be described with reference to a flowchart of FIG. 19.

The process of steps S171 to 174 of the flowchart of FIG. 19 is similar to the process of steps S151 to 154 of the flowchart of FIG. 17 except for the process when a determination result in step S172 is NO, and thus a description thereof will not be given.

In other words, when it is determined in step S172 that the block including the writing target PTU is not erasable, the process proceeds to step S175. In step S175, the CPU 13 determines whether or not there is another erasable block, that is, a block for which all physical TUs are set to DIRTY by rewriting of data of a logical TU or notification of an unnecessary logical TU number.

When it is determined in step S175 that there is another erasable block, the process proceeds to step S176. In step S176, the CPU 13 writes data to be written (copied) in a physical TU of a writing destination (a copy destination), and writes a block number (an erasing block number) of another erasable block in an expansion region of the physical TU of the writing destination (the copy destination).

Then, in step S177, the CPU 13 erases another erasable block, and then the process ends.

However, when it is determined in step S175 that there is no erasable block, the process proceeds to step S178. In step S178, the CPU 13 writes data to be written (copied) in the physical TU of the writing destination (the copy destination), and then the process ends.

According to the above-described process, a block number (an erasing block number) of a block which becomes already erasable by notification of the unnecessary logical TU number is stored together with data copied from a block by the data process. Thus, even when power is disconnected in the process of erasing a block in a predetermined data process, a block in a halfway state can be reliably erased with reference to the erasing block number at the time of re-activation.

According to the embodiments of the present technology, the following effects can be obtained. (1) Since the unnecessary logical TU information (the unnecessary logical TU number) is stored in the logical-physical translation layer, and the unnecessary logical TU is not uselessly copied at the time of the fold process, it is possible to improve rewriting performance and increase the lifespan of the NAND flash memory. (2) Since the unnecessary logical TU information is stored in the memory at the time of a normal operation and written in the NAND flash memory directly before power is disconnected, it is possible to suppress a writing load on the NAND flash memory without depending on a specific file system and recover the unnecessary logical TU information at the time of re-activation. (3) Since the file system notifies of information representing an unused region (an empty region) as the unnecessary logical TU information at the time of re-activation, it is possible to suppress a writing load on the NAN D flash memory and recover the unnecessary logical TU information at the time of re-activation. (4) Since a block number of a block which becomes erasable in the fold process is stored in another block, even when power is disconnected in the process of erasing an erasable block and the block enters a halfway state, it is possible to specify the block and reliably erase the block.

In the above example, the present technology is assumed to be applied to the memory management device that performs access management of the NAND flash memory, but the present technology can be applied to a memory management device that performs access management of any other non-volatile memory.

Further, the embodiments of the present technology can be applied to various device including storage devices using a non-volatile memory, personal computers, display devices such as television receivers, portable communication devices such as mobile phones, video/music reproducing devices (or video/music recording and reproducing devices), and game devices. Further, the embodiments of the present technology can be applied to a control integrated circuit (IC) of a recording medium integrated into various devices mentioned above.

The above-described series of processing may be performed by hardware or may be performed by software. When the series of processing is performed by software, a program forming the software is installed into a computer that is incorporated in a dedicated hardware, or installed from a program storage medium into a general-purpose personal computer, for example, that can perform various types of functions by installing various types of programs.

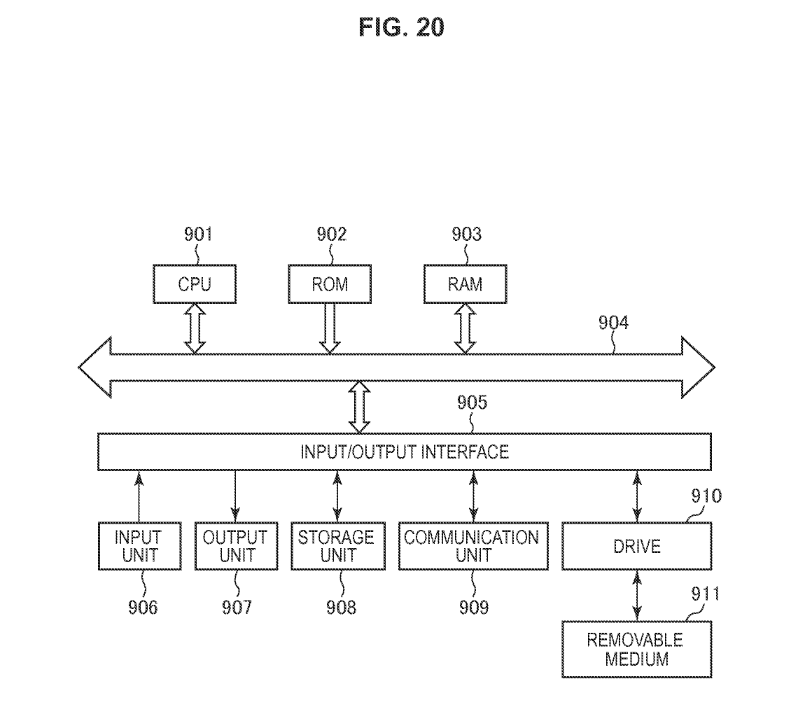

FIG. 20 is a block diagram showing a hardware configuration example of a computer that performs the above-described series of processing using a program.

In the computer, a central processing unit (CPU) 901, a read only memory (ROM) 902 and a random access memory (RAM) 903 are mutually connected by a bus 904. In addition, the CPU 901 corresponds to the CPU 13 serving as the control unit according to the present technology, and the ROM 902 and the RAM 903 correspond to the memory 12 serving as a holding unit according to the present technology.

Further, an input/output interface 905 is connected to the bus 904. Connected to the input/output interface 905 are an input unit 906 formed by a keyboard, a mouse, a microphone and the like, an output unit 907 formed by a display a speaker and the like, a storage unit 908 formed by a hard disk, a nonvolatile memory and the like, a communication unit 909 formed by a network interface and the like, and a drive 910 that drives a removable medium 911 that is a magnetic disk, an optical disk, a magneto-optical disk, or a semiconductor memory etc. The storage unit 908 corresponds to the NAND flash memory 11 serving as the non-volatile memory according to the present technology.

In the computer configured as described above, the CPU 901 loads a program that is stored, for example, in the storage unit 908 onto the RAM 903 via the input/output interface 905 and the bus 904, and executes the program. Thus, the above-described series of processing is performed.

The program executed by the computer (the CPU 901) is recorded in the removable medium 911, which is a package media formed by; for example, a magnetic disc (including a flexible disk), an optical disk (a compact disc read only memory (CD-ROM), a digital versatile disc (DVD) or the like), a magneto optical disk, or a semiconductor memory etc. Alternatively, the program is provided via a wired or wireless transmission media, such as a local area network, the Internet and a digital satellite broadcast.

Then, by inserting the removable medium 911 into the drive 910, the program can be installed in the storage unit 908 via the input/output interface 905. Further, the program can be received by the communication unit 909 via a wired or wireless transmission media and installed in the storage unit 908. Moreover, the program can be installed in advance in the ROM 902 or the storage unit 908.

It should be noted that the program executed by a computer may be a program that is processed in time series according to the sequence described in this specification or a program that is processed in parallel or at necessary timing such as upon calling.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) A memory management device, including:

a non-volatile memory that performs writing and reading of data on a per-page basis, and performs erasing on a per-block basis; and

a control unit that manages a data process in the non-volatile memory by performing logical-physical translation on a per-translation unit (TU) basis, and performs a fold process,

wherein the control unit sets data of a physical TU corresponding to unnecessary logical TU information to be excluded from a copy target in the fold process based on the unnecessary logical TU information, the unnecessary logical TU information being notified of by a file system and representing a logical TU corresponding to a physical TU in which unnecessary data is physically written.

(2) The memory management device according to (1), further including

a holding unit that holds the unnecessary logical TU information.

(3) The memory management device according to (2),

wherein the control unit causes the unnecessary logical TU information held in the holding unit to be stored in the non-volatile memory as data on the file system before power is disconnected, and causes the file system to perform notification of the unnecessary logical TU information stored in the non-volatile memory at a time of activation.

(4) The memory management device according to (2),

wherein the control unit stores the unnecessary logical TU information held in the holding unit in a physical TU of the non-volatile memory to which a predetermined logical TU number is set before power is disconnected, and causes the file system to perform notification of the unnecessary logical TU information stored in a physical TU to which the predetermined logical TU number is set at a time of activation.

(5) The memory management device according to (2),

wherein the control unit causes the file system to generate and perform notification of the unnecessary logical TU information based on information related to an unused region included in management information of the file system.

(6) The memory management device according to any one of (2) to (5),

wherein the holding unit holds a physical TU state map for managing a state of each physical TU and an unnecessary logical TU list storing the unnecessary logical TU information, and

wherein, when the file system notifies the control unit of the unnecessary logical TU information, the control unit sets a state of a physical TU corresponding to the unnecessary logical TU information in the physical TU state map to a written invalid physical TU, and adds the notified unnecessary logical TU information to the unnecessary logical TU list.

(7) The memory management device according to (6),

wherein the holding unit further holds a logical-physical translation table in which an address of a logical TU is associated with an address of a physical TU, and

wherein, when the file system notifies the control unit of the unnecessary logical TU information, the control unit sets an address of a physical TU corresponding to the unnecessary logical TU information to undefined in the logical-physical translation table.

(8) The memory management device according to (6),

wherein the control unit erases the block when all the states of the physical TUs included in the block are set to written invalid physical TUs in the physical TU state map.

(9) The memory management device according to (8),

wherein, when the block including a physical TU serving as a copy source of data becomes erasable as a result of a data process, the control unit writes a block number representing the block which becomes erasable in the unwritten physical TU to which the data is to be copied in the data process, and erases the block.

(10) The memory management device according to (9),

wherein the data process is rewriting of data of a logical TU in response to a request from the file system.

(11) The memory management device according to (9),

wherein the data process is the fold process.

(12) The memory management device according to any one of (9) to (11),

wherein, when the block including a physical TU serving as a copy source of data does not become erasable, and another block becomes erasable as a result of the data process, the control unit writes a block number representing the other block which becomes erasable in the unwritten physical TU to which the data is to be copied in the data process, and erases the other block.

(13) A memory management method of a memory management device including a non-volatile memory that performs writing and reading of data on a per-page basis, and performs erasing on a per-block basis, and a control unit that manages a data process in the non-volatile memory by performing logical-physical translation on a per-translation unit (TU) basis, and performs a fold process, the memory management method including:

setting, by the memory management device, data of a physical TU corresponding to unnecessary logical TU information to be excluded from a copy target in the fold process based on the unnecessary logical TU information, the unnecessary logical TU information being notified of by a file system and representing a logical TU corresponding to a physical TU in which unnecessary data is physically written.

(14) A program for causing a computer, which includes a non-volatile memory that performs writing and reading of data on a per-page basis, and performs erasing on a per-block basis, and a control unit that manages a data process in the non-volatile memory by performing logical-physical translation on a per-translation unit (TU) basis, and performs a fold process, to execute

setting data of a physical TU corresponding to unnecessary logical TU information to be excluded from a copy target in the fold process based on the unnecessary logical TU information, the unnecessary logical TU information being notified of by a file system and representing a logical TU corresponding to a physical TU in which unnecessary data is physically written.

The present disclosure contains subject matter related to that disclosed in Japanese Priority Patent Application JP 2012-122852 filed in the Japan Patent Office on May 30, 2012, the entire content of which is hereby incorporated by reference.

What is claimed is:

1. A memory management device, comprising:
a non-volatile memory that performs writing and reading of data on a per-page basis, and performs erasing on a per-block basis; and
a control unit that manages a data process in the non-volatile memory by performing logical-physical translation on a per-translation unit (TU) basis, and performs a fold process,
wherein the control unit sets data of a physical TU corresponding to unnecessary logical TU information to be excluded from a copy target in the fold process based on the unnecessary logical TU information, the unnecessary logical TU information being notified of by a file system and representing a logical TU corresponding to a physical TU in which unnecessary data is physically written.

2. The memory management device according to claim 1, further comprising
a holding unit that holds the unnecessary logical TU information.

3. The memory management device according to claim 2,
wherein the control unit causes the unnecessary logical TU information held in the holding unit to be stored in the non-volatile memory as data on the file system before power is disconnected, and causes the file system to perform notification of the unnecessary logical TU information stored in the non-volatile memory at a time of activation.

4. The memory management device according to claim 2,
wherein the control unit stores the unnecessary logical TU information held in the holding unit in a physical TU of the non-volatile memory to which a predetermined logical TU number is set before power is disconnected, and causes the file system to perform notification of the unnecessary logical TU information stored in a physical TU to which the predetermined logical TU number is set at a time of activation.

5. The memory management device according to claim 2,
wherein the control unit causes the file system to generate and perform notification of the unnecessary logical TU information based on information related to an unused region included in management information of the file system.

6. The memory management device according to claim 2,
wherein the holding unit holds a physical TU state map for managing a state of each physical TU and an unnecessary logical TU list storing the unnecessary logical TU information, and
wherein, when the file system notifies the control unit of the unnecessary logical TU information, the control unit sets a state of a physical TU corresponding to the unnecessary logical TU information in the physical TU state map to a written invalid physical TU, and adds the notified unnecessary logical TU information to the unnecessary logical TU list.

7. The memory management device according to claim 6,
wherein the holding unit further holds a logical-physical translation table in which an address of a logical TU is associated with an address of a physical TU, and
wherein, when the file system notifies the control unit of the unnecessary logical TU information, the control unit sets an address of a physical TU corresponding to the unnecessary logical TU information to undefined in the logical-physical translation table.

8. The memory management device according to claim 6,
wherein the control unit erases the block when all the states of the physical TUs included in the block are set to written invalid physical TUs in the physical TU state map.

9. The memory management device according to claim 8,
wherein, when the block including a physical TU serving as a copy source of data becomes erasable as a result of a data process, the control unit writes a block number representing the block which becomes erasable in the unwritten physical TU to which the data is to be copied in the data process, and erases the block.

10. The memory management device according to claim 9,
wherein the data process is rewriting of data of a logical TU in response to a request from the file system.

11. The memory management device according to claim 9,
wherein the data process is the fold process.

12. The memory management device according to claim 9,
wherein, when the block including a physical TU serving as a copy source of data does not become erasable, and another block becomes erasable as a result of the data process, the control unit writes a block number representing the other block which becomes erasable in the unwritten physical TU to which the data is to be copied in the data process, and erases the other block.

13. A memory management method of a memory management device including a non-volatile memory that performs writing and reading of data on a per-page basis, and performs erasing on a per-block basis, and a control unit that manages a data process in the non-volatile memory by performing logical-physical translation on a per-translation unit (TU) basis, and performs a fold process, the memory management method comprising:
setting, by the memory management device, data of a physical TU corresponding to unnecessary logical TU information to be excluded from a copy target in the fold process based on the unnecessary logical TU information, the unnecessary logical TU information being notified of by a file system and representing a logical TU corresponding to a physical TU in which unnecessary data is physically written.

14. A program for causing a computer, which includes a non-volatile memory that performs writing and reading of data on a per-page basis, and performs erasing on a per-block basis, and a control unit that manages a data process in the non-volatile memory by performing logical-physical translation on a per-translation unit (TU) basis, and performs a fold process, to execute
setting data of a physical TU corresponding to unnecessary logical TU information to be excluded from a copy target in the fold process based on the unnecessary logical TU information, the unnecessary logical TU information being notified of by a file system and representing a logical TU corresponding to a physical TU in which unnecessary data is physically written.
